(19) United States
(12) Patent Application Publication
(10) Pub. No.: US 2026/0326021 A1
(43) Pub. Date: Oct. 22, 2026

(54) A PROCESS FOR CAPTURING CO2 FROM AIR

(71) Applicant: SHELL USA, INC., Houston, TX (US)

(72) Inventors: Sumit VERMA, Quincy, MA (US); Sayee Prasaad BALAJI, Amsterdam (NL); Paul Joseph CORBETT, London (GB)

(21) Appl. No.: 18/994,886

(22) PCT Filed: Jul. 19, 2023
(86) PCT No.: PCT/EP2023/069987

§ 371 Date: Jan. 15, 2025

Related U.S. Application Data
(60) Provisional application No. 63/391,068, filed on Jul. 21, 2022.

(30) Foreign Application Priority Data
Aug. 5, 2022 (EP) 22189142.7

(51) Int. Cl. B01D 53/14; B01D 53/18; B01D 53/62; B01D 53/96

(52) U.S. Cl. CPC B01D 53/1475; B01D 53/1425; B01D 53/18; B01D 53/62; B01D 53/965; B01D 2252/10; B01D 2257/504; B01D 2258/06

(57) ABSTRACT

A process for capturing CO2 from a CO2-containing gas stream at least comprising the steps:
(a) providing a CO2-containing gas stream (10);
(b) contacting stream (10) in a contactor (2) with liquid solvent (30), obtaining a CO2-depleted gas stream (20) and a CO2-loaded solvent stream (40);
(c) splitting the stream (40) obtaining a second CO2-loaded solvent stream (70) and a CO2-loaded solvent stream (50);
(d) temporarily storing the stream (70) in a first tank (3);
(e) passing CO2-loaded solvent (80) from the tank (3) to an electrochemical device (4);
(f) subjecting the solvent (80) to an electrochemical reaction, obtaining a gas/liquid mixture (100);
(g) separating the mixture (100) in a separator (5), obtaining a gas stream (130) and a liquid stream (140);
(h) temporarily storing the stream (140) in a tank (6);
(i) recycling liquid (160) from tank (6) to the contactor (2) for use as the solvent (30).

The present invention relates to a process for capturing carbon dioxide (CO₂) from a CO₂-containing gas stream, in particular air. In particular, the present invention relates to electrochemical CO₂ capture from the atmosphere.

Processes for electrochemical CO₂ capture from the atmosphere are known in the art and have been proposed in helping to address human induced climate change.

This, as the increasing availability of low-cost renewable electricity and the desire to decrease carbon emissions through CO₂ capture presents an opportunity to produce carbon-based feedstocks and fuels via the electrochemical reduction of carbon dioxide (CO₂) to chemical feedstocks. As a result, there has been an increasing amount of research into identifying pathways of electrochemical CO₂ capture and subsequent downstream processing.

As a mere example, the article by M. D. Eisaman et al., “Energy-efficient electrochemical CO₂ capture from the atmosphere” in Technical Proceedings of the 2009 Clean Technology Conference and Trade Show, May 2009, pages 3-7, discloses experimental progress towards energy-efficient electrochemical CO₂ capture using a pH-controlled, high pressure (10-100 atm.) electrodialysis system.

A problem of the process as described in this article is that—although no use of renewable electricity has been proposed in the article by Eisaman—it is unclear how intermittency issues would be handled when renewable power would be used. Most likely, expensive battery storage would be needed to run the electrochemical device and the CO₂ contactor continuously.

Another problem is that when CO₂ would be regenerated from an electrolyte as used in the electrochemical device at elevated pressures (e.g. greater than 10 bar), this would leave substantial amounts of CO₂ dissolved in the electrolyte in view of the higher solubility of CO₂. When regenerating CO₂ at ambient pressure, this would require expensive multistage compressors to make the CO₂ suitable for downstream applications.

It is an object of the present invention to solve, minimize or at least reduce one or more of the above problems.

It is a further object of the present invention to provide an alternative process for capturing CO₂ from the atmosphere.

One or more of the above or other objects may be achieved according to the present invention by providing a process for capturing carbon dioxide (CO₂) from a CO₂-containing gas stream, in particular air, the process at least comprising the steps of:
(a) providing a CO₂-containing gas stream;
(b) contacting the CO₂-containing gas stream provided in step (a) in a contactor with a liquid solvent thereby obtaining a CO₂-depleted gas stream and a first CO₂-loaded solvent stream;
(c) splitting the first CO₂-loaded solvent stream obtained in step (b), thereby obtaining a second CO₂-loaded solvent stream and a third CO₂-loaded solvent stream;
(d) temporarily storing the second CO₂-loaded solvent stream obtained in step (c) in a first tank;
(e) passing CO₂-loaded solvent from the first tank to an electrochemical device;
(f) subjecting the CO₂-loaded solvent in the electrochemical device to an electrochemical reaction thereby obtaining a gas/liquid mixture;
(g) separating the gas/liquid mixture obtained in step (f) in a gas/liquid separator thereby obtaining a gas stream and a first liquid stream;
(h) temporarily storing the first liquid stream obtained in step (g) in a second tank;
(i) recycling first liquid from the second tank to the contactor for use as the liquid solvent in step (b).

It has surprisingly been found according to the present invention that by the use of two storage tanks for CO₂-loaded solvent and regenerated solvent, intermittency issues for the electrochemical device can be overcome or at least minimized. By using low-cost storage facilities for the solvent, the use of relatively expensive batteries to ensure a (n otherwise needed) continuous operation of the electrochemical device can be avoided in case the electrochemical device is driven by renewable power such as wind, solar and other forms of renewable power that has intermittency issues; this, as in case the electrochemical device is not working because of intermittency issues, the stored solvent can be used.

In step (a) of the process according to the present invention, a CO₂-containing gas stream is provided. Although the CO₂-containing gas stream is not limited in any way (in terms of composition, temperature, pressure, etc.) and may have various origins, it is preferably air.

Preferably, the CO₂-containing stream provided in step (a) comprises at most 5.0 mol. % CO₂, preferably at most 2.0 mol. % CO₂, more preferably at most 1.0 mol. % CO₂, even more preferably at most 600 ppm CO₂. Preferably, the CO₂-containing stream provided in step (a) comprises at least 400 ppm CO₂.

In step (b), the CO₂-containing gas stream provided in step (a) is contacted in a contactor (preferably an air-liquid contactor) with a liquid solvent thereby obtaining a CO₂-depleted gas stream and a first CO₂-loaded solvent stream.

Although not particularly limited, the CO₂-containing gas stream contacted in step (b) typically has atmospheric conditions. Preferably, the CO₂-containing gas stream contacted in step (b) has a pressure in the range of 0.5-1.5 bara, preferably 0.9-1.1 bara.

As the person skilled in the art is familiar with contactors (and in particular gas-liquid contactors, including air-liquid contactors), this will not be discussed here in detail. Examples of known gas-liquid contactors have been disclosed in the article D. W. Keith et al., “A process for capturing CO₂ from the atmosphere”, Joule, 2(8), 1573-1594, 2018 and in the article by G. Holmes et al., “An air-liquid contactor for large-scale capture of CO₂ from air”, Philosophical Transactions of the Royal Society A (2012), 370, 4380-4403.

Also, the person skilled in the art will understand that the (first) ‘CO₂-loaded solvent stream’ means that the solvent may have adsorbed or absorbed the CO₂ by ‘physisorption’ or ‘chemisorption’. In the latter case, conversion of the CO₂ may have taken place.

The person skilled in the art will readily understand that the liquid solvent as used in step (b) is not particularly limited and can be selected from a wide range of available options.

Preferably, the liquid solvent in step (b) comprises an aqueous solution comprising a metal carbonate and a metal hydroxide. Typically, the metals of the metal carbonate and the metal hydroxide are both independently selected from alkali or alkaline earth metals.

Preferably, the metal of the metal carbonate and the metal hydroxide is the same and selected from the group consisting of potassium (K), sodium (Na), lithium (Li), magnesium (Mg) or mixtures thereof. Most preferably the metal is K; in the latter case, the aqueous solution comprises potassium carbonate (K₂CO₃), potassium hydroxide (KOH) and some KHCO₃ as well.

Generally, the aqueous solution comprises 0.1-5.0 mol %, preferably 0.5-2.5 mol % of the metal carbonate and 0.1-10.0 mol %, preferably 0.5-5.0 mol % of the metal hydroxide. Typically, the balance is water.

Preferably, the liquid solvent in step (b) has a pressure in the range of 0.5-1.5 bara, preferably 0.9-1.1 bara.

Although the contacting temperature in the contactor is not particularly limited, it typically takes place at a temperature in the range of from 10 to 90° C., preferably from 15 to 80° C., more preferably below 65° C.

In step (c) of the process according to the present invention, the first CO₂-loaded solvent stream obtained in step (b) is split, thereby obtaining at least a second CO₂-loaded solvent stream and a third CO₂-loaded solvent stream. Preferably, the third CO₂-loaded solvent stream is combined with the liquid solvent stream as used in the contactor in step (b). However, instead or in addition, at least a part or all of the third CO₂-loaded solvent stream may be temporarily stored in the second tank.

Preferably, the volume ratio of the third CO₂-loaded solvent stream (when combined with the liquid solvent stream as used in the contactor in step (b)) recycled to the and the first CO₂-loaded solvent stream is between 0.3-0.99, more preferably 0.65-0.95. This to ensure suitable solvent utilization levels in the contactor of step (b) without needing too many of such contactors.

In step (d) of the process according to the present invention, the second CO₂-loaded solvent stream obtained in step (c) is temporarily stored in a first tank.

The first tank is not particularly limited and is typically a low-cost storage tank. An important advantage of the use of such a storage tank is that in case the electrochemical device as used in step (e) is driven by renewable power such as wind, solar and other forms of renewable power intermittency issues can be accommodated without the use of expensive batteries. A further advantage of the use of a storage tank, is that it can be easily scaled up.

In step (e), CO₂-loaded solvent is passed from the first tank to an electrochemical device.

Preferably, the CO₂-loaded solvent being passed in step (e) from the first tank to the electrochemical device is pressurized to a pressure in the range of 5.0-50.0 bara, preferably 9.0-30.0 bara.

According to an especially preferred embodiment of the present invention, the electrochemical device is driven by renewable power. Renewable power can be either intermittent or continuous.

As the person skilled in the art is familiar with electrochemical devices, these will not be discussed here in full detail. In general, an electrochemical device uses electricity to drive an otherwise non-spontaneous chemical reaction. The electrochemical device will typically comprise at least an anode and a cathode separated by a membrane, and electrolyte. Preferred examples of electrochemical devices to be used in the process according to the present invention are ‘electrodialysis units’ and ‘electrolyzers’ which are known per se in the art.

An example of an electrodialysis unit has for example been given in the above-mentioned article by Eisaman. A comprehensive overview of different designs for electrodialysis units has been given in the recent article by F. Sabatino et al., “Evaluation of a direct air capture process combining wet scrubbing and bipolar membrane electrodialysis” in Industrial & Engineering Chemistry Research, 2020, 59(15), 7007-7020.

The person skilled in the art will readily understand that the components of the electrodialysis unit may be constructed from a wide range of materials.

Typically, an electrodialysis unit consists of at least a feed compartment and a concentrate compartment formed by an anion exchange membrane and a cation exchange membrane placed between two electrodes (cathode and anode).

The cathode as used in the electrodialysis unit is not particularly limited. Generally, the cathode of the electrodialysis unit is selected from nickel, iron, steel, platinum, palladium, aluminum, carbon black, carbon nanotubes, graphene, or combinations thereof. Preferably, the cathode comprises a metal selected from the group consisting of nickel (Ni), Iron (Fe), and steel.

Also, the anode as used in the electrodialysis unit is not particularly limited. Preferably, the anode comprises a metal selected from the group consisting of nickel (Ni), iron (Fe), iridium (Ir), cobalt (Co), manganese (Mn), ruthenium (Ru) or combinations thereof. The anode may comprise an oxide of the above metals.

The electrolyte as used in the electrodialysis unit according to the present invention is typically defined by the liquid solvent as used in in the contactor in step (b) as CO₂-loaded solvent is used as fluid in the electrodialysis unit. Hence, as discussed above for the liquid solvent, the electrolyte as used in the electrodialysis unit comprises preferably an aqueous solution comprising a metal carbonate and a metal hydroxide, the metal being preferably K.

For an example of an electrolyzer, reference is made to the article by Y. C. Lee et al., “CO₂ electroreduction from carbonate electrolyte” in ACS Energy Letters, 2019, 4(6), 1427-1431.

The person skilled in the art will readily understand that the components of the electrolyzer may be constructed from a wide range of materials. Typically, an electrolyzer comprises at least a cathode, an anode, an electrolyte and a membrane.

The cathode as used in the electrolyzer is not particularly limited. Generally, the cathode of the electrolyzer is selected from copper, silver, gold, platinum, tin, lead, palladium, aluminium, zinc, titania, carbon black, carbon nanotubes, graphene (with or without nitrogen, sulphur, phosphorus doping) or combinations thereof. Preferably, the electrolyzer in step (e) has a cathode that comprises a metal selected from the group consisting of copper (Cu), a copper-based alloy, silver (Ag) and a silver-based alloy.

Also, the anode as used in the electrolyzer is not particularly limited. Preferably, the electrolyzer in step (e) has an anode that comprises a metal selected from the group consisting of nickel (Ni), iron (Fe), iridium (Ir), cobalt (Co), manganese (Mn), ruthenium (Ru) or combinations thereof. The anode may comprise an oxide of the above metals.

The electrolyte as used in the electrolyzer is also not particularly limited. Typically, the electrolyte is an aqueous electrolyte containing a compound selected from the group consisting of carbonates, bicarbonates, hydroxides, halides of Na⁺, K⁺, Rb⁺, Cs⁺, NH₄⁺, deionized water, preferably KOH.

Although the membrane to be used in the electrolyzer is not particularly limited, preferably a bipolar membrane is used.

In step (f) of the process according to the present invention, the CO₂-loaded solvent is subjected in the electrochemical device to an electrochemical reaction thereby obtaining a gas/liquid mixture.

Although the temperature at which the electrochemical device is operated is not limited, preferably the electrochemical device in step (f) is operated at a temperature of from 10 to 100° C., preferably from 20 to 80° C. Further, preferably, the electrochemical device is operated at a pressure of 5.0-50 bara, preferably 9-30 bara.

In step (g) of the process according to the present invention, the gas/liquid mixture obtained in step (e) is separated in a gas/liquid separator thereby obtaining a gas stream and a first liquid stream. In case an electrodialysis unit is used as the electrochemical device, the gas stream obtained in step (g) is a CO₂-rich stream (typically containing at least 50 mol. % CO₂, preferably at least 90 mol. % CO₂). In case an electrolyzer is used as the electrochemical device, the gas stream obtained in step (g) is a CO-rich stream (typically containing at least 50 mol. % CO, preferably at least 80 mol. % CO).

Preferably, the gas stream obtained in step (g) has a higher pressure than the first liquid stream obtained in step (g). Typically, the gas stream obtained in step (g) has a pressure in the range of 8-30 bara and the first liquid stream obtained in step (g) has a pressure in the range of 0.9-5 bara.

Preferably, the gas/liquid separator as used in step (g) comprises a gas recovery train. An important advantage of the use of a gas recovery train as (at least part of) the gas/liquid separator is that the energy consumption and the CAPEX will be lower when compared to regenerating CO₂/CO at 1 bar pressure (to minimize any CO₂/CO left in the solvent), followed by compression in a multistage compressor.

The compressor stages in such a gas recovery train will typically be smaller than usual multistage compressors. This, as a fraction of the CO₂ will be recovered at the desired high pressure (e.g. 30 bar) requiring no compression, another fraction at an intermediate high pressure (e.g. 10 bar) requiring only 1 stage compression, another fraction at an intermediate low pressure (e.g. 3 bar) requiring two-stage compression, leaving only a very small fraction at low pressure (e.g. 1 bar) which needs the most compression (three-stage compression).

The gas recovery train is not particularly limited and can contain several stages. Typically, the gas recovery train comprises a series of gas/liquid separators which interact with a compressor train comprising a series of compressors. Preferably the gas recovery train comprises at least a first gas/liquid separator operating at a first pressure, wherein the liquid separated from the first gas/liquid separator is further separated in a second gas/liquid separator which is operated at a lower pressure than the first gas/liquid separator. Again, the liquid separated from the second gas/liquid separator may be further separated in a third gas/liquid separator which is operated at a lower pressure than the second gas/liquid separator. Fourth and subsequent gas/liquid separators may be used. The gaseous stream separated from the first, second, third and further gas/liquid separator may be compressed in the series of compressors in the compressor train.

Generally, during the electrochemical reaction in the electrochemical device in step (f) and the subsequent separation in the gas/liquid separator in step (g), the CO₂ is removed from the CO₂-loaded solvent to regenerate the solvent.

In case the electrochemical device is an electrodialysis unit, then the CO₂-loaded solvent interacts with H⁺-ions generated at the membranes in the device (via water splitting to form H⁺ and OH⁻) thereby forming an enriched H₂CO₃ stream and liberating cationic species (e.g., K⁺) that were displaced by the H⁺-ions. The liberated cationic species then react with the OH⁻ species generated at the membrane and the dilute H₂CO₃ stream coming back from the gas/liquid separator to regenerate the solvent.

Hence, preferably, in case the electrochemical device is an electrodialysis unit, the first liquid obtained in step (g) is, before being stored in step (h) in the second tank, converted in (the electrodialysis unit being used as) the electrochemical device.

According to an especially preferred embodiment of the process according to the present invention, the contactor in step (b) operates continuously and the electrochemical device in step (f) operates intermittently.

In case the electrochemical device is an electrolyzer, then the CO₂-loaded solvent interacts with H⁺-ions generated at the membranes in the device (via water splitting thereby forming H⁺ and OH⁻) to form an enriched H₂CO₃ stream in-situ which then gets electrochemically converted to CO and H₂ (or other hydrocarbon species such as ethylene) at the cathode catalyst layer and regenerates the liquid solvent use for CO₂ capture. The OH-produced at the membrane moves to the anode catalyst to liberate O₂ and water.

In step (h) of the process according to the present invention, the first liquid stream obtained in step (g) is temporarily stored in a second tank.

Like the first tank, the second tank is not particularly limited and is typically a low-cost storage tank. Again, an important advantage of the use of such a storage tank is that in case the electrochemical device as used in step (e) is driven by renewable power such as wind, solar and other forms of renewable power intermittency issues can be accommodated without the use of expensive batteries. A further advantage of the use of a storage tank, is that it can be easily scaled up.

In step (i), first liquid from the second tank is recycled to the contactor for use as the liquid solvent in step (b).

In another aspect, the present invention provides an apparatus suitable for performing the process for capturing carbon dioxide (CO₂) from a CO₂-containing gas stream according to the present invention, the apparatus at least comprising:
a contactor for contacting a CO₂-containing gas stream with a liquid solvent thereby obtaining a CO₂-depleted gas stream and a first CO₂-loaded solvent stream;
a splitter for splitting the first CO₂-loaded solvent stream, thereby obtaining a second CO₂-loaded solvent stream and a third CO₂-loaded solvent stream;
a first tank for temporarily storing the second CO₂-loaded solvent stream;
an electrochemical device for subjecting CO₂-loaded solvent stream as passed from the first tank to an electrochemical reaction thereby obtaining a gas/liquid mixture;
a gas/liquid separator for separating the gas/liquid mixture thereby obtaining a gas stream and a first liquid stream;
a second tank for temporarily storing the first liquid stream;
a recycle line for recycling first liquid from the second tank to the contactor for use as the liquid solvent.

Preferably, the apparatus further comprises a line for passing the first liquid obtained in the gas/liquid separator through the electrochemical device, before being stored in the second tank.

Hereinafter the present invention will be further illustrated by the following non-limiting drawings. Herein shows:

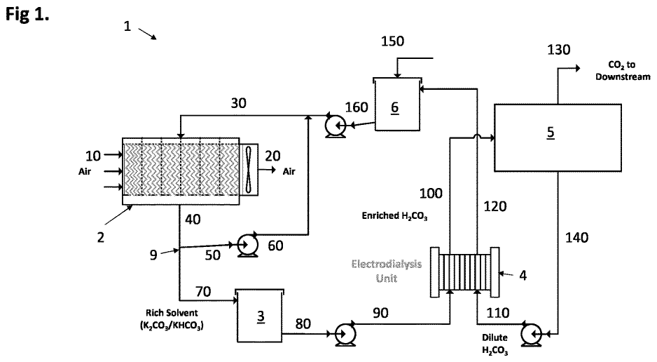

FIG. 1 schematically a flow scheme of a first embodiment of the process for capturing CO₂ according to the present invention, wherein an electrodialysis unit is used as the electrochemical device;

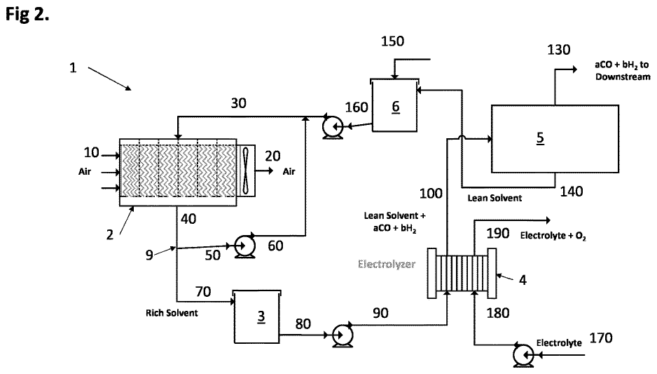

FIG. 2 schematically a flow scheme of a second embodiment of the process for capturing CO₂ according to the present invention, wherein an electrolyzer is used as the electrochemical device; and

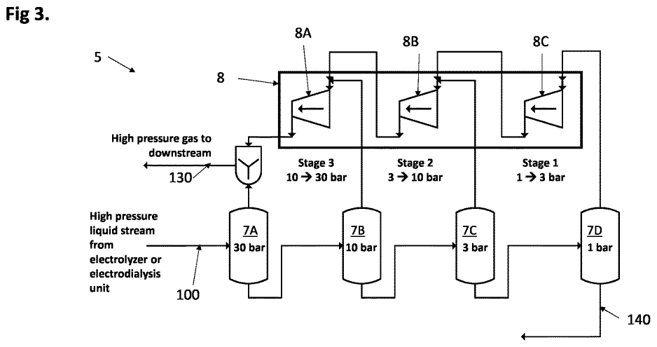

FIG. 3 a flow scheme of a gas recovery train that can be used in FIG. 1 and FIG. 2.

For the purpose of this description, same reference numbers refer to same or similar components.

The flow scheme of FIG. 1 generally referred to with reference number 1, shows an air-liquid contactor 2, a first tank 3, an electrochemical device 4 (i.e., an electrodialysis unit), a gas/liquid separator 5 (in the form of a gas recovery train, which will be further discussed in FIG. 3), a second tank 6, a splitter 9 and several pumps.

During use of the apparatus 1 of FIG. 1, a CO₂-containing gas stream 10 is provided, which is typically air.

The CO₂-containing gas stream 10 is contacted in the air-liquid contactor 2 with a liquid solvent 30 thereby obtaining a CO₂-depleted gas stream 20 and a first CO₂-loaded solvent stream 40. The first CO₂-loaded solvent stream 40 is split, thereby obtaining at least a second CO₂-loaded solvent stream 70 and a third CO₂-loaded solvent stream 50.

In the embodiment of FIG. 1, the first CO₂-loaded solvent stream 40 is in part (as third CO₂-loaded solvent stream 50) recycled for reuse in the contactor 2 (and to that end-after pumping-combined with stream 30 as stream 60). If desired, part of the third CO₂-loaded solvent stream 50 may be sent to e.g. the second tank 6; however, preferably, all of the third CO₂-loaded solvent stream 50 is combined (after pumping) as stream 60 with stream 30.

Another part (second CO₂-loaded solvent stream 70) of the first CO₂-loaded solvent stream 40 is temporarily stored in the first tank 3. From the first tank 3, CO₂-loaded solvent 80 is passed (after pumping) as stream 90 to the electrodialysis unit 4, where it is subjected to an electrochemical reaction thereby obtaining a gas/liquid mixture 100.

The gas/liquid mixture 100 is then separated in the gas/liquid separator 5 thereby obtaining a gas stream 130 and a first liquid stream 140. The CO₂-rich gas stream 130 is sent to downstream processing (such as underground storage or used as a product in other processes). The first liquid stream 140 is temporarily stored in the second tank 6.

In the embodiment of FIG. 1, where the electrochemical device is an electrodialysis unit, the first liquid 140 is, before being stored in the second tank 6, converted in the electrodialysis unit 4 and sent as stream 120 to the second tank 6. During this conversion of the first liquid 140 in the electrodialysis unit 4, the cations and OH-ions that were liberated in the previous electrochemical reaction in the electrodialysis unit 4 to obtain the gas/liquid mixture 100 (which could e.g. be an enriched H₂CO₃ stream) are collected and converted into the liquid solvent (which could e.g. be cation-OH) used for the capture of CO₂. This liquid solvent is then sent as stream 120 to the second tank 6.

From the second tank 6, liquid solvent is recycled to the contactor 2 for use as the liquid solvent 30.

As shown in FIG. 1, make-up solvent stream 150 may be added to the second tank if desired.

FIG. 2 shows an alternative embodiment of the process according to the present invention, wherein the electrochemical device 4 is an electrolyzer (instead of the electrodialysis unit as used in FIG. 1).

As can be seen in FIG. 2, the first liquid 140 as obtained in the gas/liquid separator 5 is directly sent to the second tank 6, without a second conversion in the electrochemical device 4. Further, in the embodiment of FIG. 2, there is a separate electrolyte cycle flowing through the electrolyzer 4, formed by electrolyte streams 170, 180 and 190. Also, the gas stream 130 is a CO-rich stream (rather than a CO₂-rich stream as is the case in FIG. 1) which is sent to downstream processing (e.g. used as a syngas product in other processes).

FIG. 3 shows a flow scheme of a gas recovery train that can be used as the gas/liquid separator 5 in FIG. 1 and FIG. 2.

As shown in FIG. 3, the gas recovery train comprises a series of gas/liquid separators 7A-7D which interact with a compressor train 8 comprising a series of compressors 8A-8C.

The gas recovery train comprises a first gas/liquid separator 7A operating at a first pressure, a second gas/liquid separator 7B operating at a second pressure, a third gas/liquid separator 7C operating at a third pressure and a fourth gas/liquid separator 7D operating at a fourth pressure. The liquid bottom stream separated from the first gas/liquid separator 7A is further separated in the second gas/liquid separator 7B which is operated at a lower pressure than the first gas/liquid separator 7A. Again, the liquid bottom stream separated from the second gas/liquid separator 7B is further separated in the third gas/liquid separator 7C which is operated at a lower pressure than the second gas/liquid separator 7B, etc. The gaseous streams separated from the first, second, third and fourth gas/liquid separators 7A-7D are compressed in the series of compressors 8A-8C in the compressor train 8.

### EXAMPLES

### Example 1—Electrodialysis Unit

The flow scheme of FIG. 1 (using an electrodialysis unit as the electrochemical device 4) was used for illustrating the capture of CO₂ according to the present invention in a non-limiting manner. The compositions and conditions of the fluid (i.e. gas and liquid) streams in the various flow lines are provided in Table 1 below (V means vapour, whilst L means liquid).

The values in Table 1 were calculated using a model generated with commercially available Aspen Plus software, whilst using standard thermodynamic packages with setting such that CO₂ conversion, gas/liquid separation, etc. are simulated.

For the electrodialysis unit, experimental data available from the above-mentioned article by M. D. Eisaman et al. in Technical Proceedings of the 2009 Clean Technology Conference and Trade Show was used to supplement the Aspen model.

As solvent, an aqueous (1.38 mol. %) KOH solution was used. The ‘CO₂-enriched’ nature of the CO₂-loaded solvent stream 40 is visible from the increased amount of K₂CO₃ when compared with the liquid solvent stream 30 (1.62 mol. % for stream 40 vs. 1.29 mol. % for stream 30).

TABLE 1

| Fluid stream | 10 | 20 | 30 | 40 | 50 | 60 | 70 | 80 | 90 | 100 |
|---|---|---|---|---|---|---|---|---|---|---|
| Phase | V | V | L | L | L | L | L | L | L | L |
| T [°C] | 21 | 19 | 21 | 18 | 18 | 18 | 18 | 18 | 18 | 21 |
| p [bara] | 1 | 1 | 1 | 1 | 1 | 1 | 1 | 1 | 10 | 10 |
| CO₂ [mol . %] | 0.04 | 0.0016 | — | — | — | — | — | — | — | 1.39 |
| N₂ [mol. %] | 77.78 | 77.46 | — | — | — | — | — | — | — | — |
| O₂ [mol. %] | 20.62 | 20.53 | — | — | — | — | — | — | — | — |
| H₂O [mol. %] | 1.56 | 2.01 | 97.33 | 97.52 | 97.52 | 97.52 | 97.52 | 97.52 | 97.52 | 98.41 |
| KOH [mol. %] | — | — | 1.38 | 0.86 | 0.86 | 0.86 | 0.86 | 0.86 | 0.86 | — |
| KHCO₃ [mol. %] | — | — | — | — | — | — | — | — | — | 0.20 |
| K₂CO₃ [mol. %] | — | — | 1.29 | 1.62 | 1.62 | 1.62 | 1.62 | 1.62 | 1.62 | — |

| Fluid stream | 110 | 120 | 130 | 140 | 150 | 160 |
|---|---|---|---|---|---|---|
| Phase | L | L | V | L | L | L |
| T [°C] | 21 | 21 | 21 | 21 | 21 | 21 |
| p [bara] | 10 | 10 | 10 | 1 | 1 | 1 |
| CO₂ [mol. %] | 0.06 | — | 97.50 | 0.06 | — | — |
| N₂ [mol . %] | — | — | — | — | — | — |
| O₂ [mol. %] | — | — | — | — | — | — |
| H₂O [mol. %] | 99.73 | 96.19 | 2.50 | 99.73 | 100.00 | 96.75 |
| KOH [mol. %] | — | 3.54 | — | — | — | 3.02 |
| KHCO₃ [mol. %] | 0.20 | — | — | 0.20 | — | — |
| K₂CO₃ [mol. %] | — | 0.27 | — | — | — | 0.23 |

### Example 2—Electrolyzer

The flow scheme of FIG. 2 (using an electrolyzer as the electrochemical device 4) was used for illustrating the capture of CO₂ according to the present invention in a non-limiting manner. The compositions and conditions of the fluid (i.e. gas and liquid) streams in the various flow lines are provided in Table 2 below.

The values in Table 2 were calculated using a model generated with commercially available Aspen Plus software, whilst using standard thermodynamic packages with setting such that CO₂ conversion, gas/liquid separation, etc. are simulated.

For the electrolyzer block, experimental data available from the above-mentioned article by Y. C. Lee et al. in ACS Energy Letters was used to supplement the Aspen model.

TABLE 2

| Fluid stream | 10 | 20 | 30 | 40 | 50 | 60 | 70 | 80 | 90 | 100 |
|---|---|---|---|---|---|---|---|---|---|---|
| Phase | V | V | L | L | L | L | L | L | L | L |
| T [°C] | 21 | 19 | 21 | 18 | 18 | 18 | 18 | 18 | 18 | 21 |
| p [bara] | 1 | 1 | 1 | 1 | 1 | 1 | 1 | 1 | 10 | 10 |
| CO₂ [mol. %] | 0.04 | 0.0016 | — | — | — | — | — | — | — | 0.13 |
| CO [mol. %] | — | — | — | — | — | — | — | — | — | 1.20 |
| H₂ [mol. %] | — | — | — | — | — | — | — | — | — | 0.06 |
| N₂ [mol. %] | 77.78 | 77.46 | — | — | — | — | — | — | — | — |
| O₂ [mol. %] | 20.62 | 20.53 | — | — | — | — | — | — | — | — |
| H₂O [mol . %] | 1.56 | 2.01 | 97.33 | 97.52 | 97.52 | 97.52 | 97.52 | 97.52 | 97.52 | 98.40 |
| KOH [mol. %] | — | — | 1.38 | 0.86 | 0.86 | 0.86 | 0.86 | 0.86 | 0.86 | — |
| KHCO₃ [mol . %] | — | — | — | — | — | — | — | — | — | 0.20 |
| K₂CO₃ [mol. %] | — | — | 1.29 | 1.62 | 1.62 | 1.62 | 1.62 | 1.62 | 1.62 | — |

| Fluid stream | 130 | 140 | 150 | 160 | 170 | 180 | 190 |
|---|---|---|---|---|---|---|---|
| Phase | V | L | L | L | L | L | L |
| T [°C] | 21 | 21 | 21 | 21 | 21 | 21 | 21 |
| p [bara] | 10 | 10 | 1 | 1 | 1 | 10 | 10 |
| CO₂ [mol. %] | 9.31 | — | — | — | — | — | — |
| CO [mol. %] | 83.80 | — | — | — | — | — | — |
| H₂ [mol. %] | 4.41 | — | — | — | — | — | — |
| N₂ [mol . %] | 0.05 | — | — | — | — | — | — |
| O₂ [mol. %] | 0.02 | — | — | — | — | — | 31.60 |
| H₂O [mol. %] | 2.41 | 96.19 | 100.00 | 96.75 | 98.02 | 98.02 | 66.50 |
| KOH [mol . %] | — | 3.54 | — | 3.02 | 1.98 | 1.98 | 1.90 |
| KHCO₃ [mol . %] | — | — | — | — | — | — | — |
| K₂CO₃ [mol. %] | — | 0.27 | — | 0.23 | — | — | — |

### DISCUSSION

As can be seen from Tables 1 and 2, the process according to the present invention allows for an effective way of capturing CO₂ from air.

An important advantage of the process according to the present invention is that the solvent can be easily stored in low-cost tanks. This can be of importance in case the electrochemical device is driven by renewable power such as wind, solar and other forms of renewable power that has intermittency issues.

The person skilled in the art will readily understand that many modifications may be made without departing from the scope of the invention. Further, the person skilled in the art will readily understand that, while the present invention in some instances may have been illustrated making reference to a specific combination of features and measures, many of those features and measures are functionally independent from other features and measures given in the respective embodiment(s) such that they can be equally or similarly applied independently in other embodiments.

1. A process for capturing carbon dioxide (CO2) from a CO2-containing gas stream, in particular air, the process at least comprising the steps of:
(a) providing a CO2-containing gas stream (10);
(b) contacting the CO2-containing gas stream (10) provided in step (a) in a contactor (2) with a liquid solvent (30) thereby obtaining a CO2-depleted gas stream (20) and a first CO2-loaded solvent stream (40);
(c) splitting the first CO2-loaded solvent stream (40) obtained in step (b), thereby obtaining a second CO2-loaded solvent stream (70) and a third CO2-loaded solvent stream (50);
(d) temporarily storing the second CO2-loaded solvent stream (70) obtained in step (c) in a first tank (3);
(e) passing CO2-loaded solvent (80) from the first tank (3) to an electrochemical device (4);
(f) subjecting the CO2-loaded solvent (80) in the electrochemical device (4) to an electrochemical reaction thereby obtaining a gas/liquid mixture (100);
(g) separating the gas/liquid mixture (100) obtained in step (f) in a gas/liquid separator (5) thereby obtaining a gas stream (130) and a first liquid stream (140);
(h) temporarily storing the first liquid stream (140) obtained in step (g) in a second tank (6);
(i) recycling first liquid (160) from the second tank (6) to the contactor (2) for use as the liquid solvent (30) in step (b).

2. The process according to claim 1, wherein the CO2-containing stream (10) provided in step (a) comprises at most 5.0 mol. % CO2, preferably at most 2.0 mol. % CO2, more preferably at most 1.0 mol. % CO2, even more preferably at most 600 ppm CO2.

3. The process according to claim 1, wherein the CO2-containing gas stream (10) contacted in step (b) has a pressure in the range of 0.5-1.5 bara, preferably 0.9-1.1 bara.

4. The process according to claim 1, wherein the liquid solvent (30) in step (b) comprises an aqueous solution comprising a metal carbonate and a metal hydroxide, wherein the metal is preferably selected from the group consisting of potassium (K), sodium (Na), lithium (Li), magnesium (Mg) or mixtures thereof, and is more preferably K.

5. The process according to claim 1, wherein the liquid solvent (30) in step (b) has a pressure in the range of 0.5-1.5 bara, preferably 0.9-1.1 bara.

6. The process according to claim 1, wherein the CO2-loaded solvent (80) being passed in step (e) from the first tank (3) to the electrochemical device (4) is pressurized to a pressure in the range of 5.0-50.0 bara, preferably 9.0-30.0 bara.

7. The process according to claim 1, wherein in step (f) the electrochemical device (4) is operated at a pressure in the range of 5.0-50.0 bara, preferably 9.0-30.0 bara.

8. The process according to claim 1, wherein the gas stream (130) obtained in step (g) has a higher pressure than the first liquid stream (140) obtained in step (g).

9. The process according to claim 1, wherein the gas/liquid separator (5) as used in step (g) comprises a gas recovery train.

10. The process according to claim 1, wherein the first liquid (140) obtained in step (g) is, before being stored in step (h) in the second tank (6), converted in the electrochemical device (4).
